(19) United States
(12) Patent Application Publication
(10) Pub. No.: US 2022/0396061 A1
(43) Pub. Date: Dec. 15, 2022

(54) WAX ALTERNATIVE WATER AND MOISTURE RESISTANT CORRUGATED BOARD

(71) Applicant: WESTROCK SHARED SERVICES, LLC, Atlanta, GA (US)

(72) Inventors: David J. WIEMANN, Chesterfield, MO (US); Paul C. HASCHKE, Carol Stream, IL (US); John D. BENSON, North Charleston, SC (US); William T. MCDONNELL, Elmhurst, IL (US)

(21) Appl. No.: 17/837,977

(22) Filed: Jun. 10, 2022

Related U.S. Application Data
(60) Provisional application No. 63/209,213, filed on Jun. 10, 2021.

(51) Int. Cl. B32B 29/00; B32B 29/08; B32B 7/12; B32B 37/12

(52) U.S. Cl. CPC B32B 29/005; B32B 29/08; B32B 7/12; B32B 37/12; B32B 2307/718; B32B 2439/00; B32B 2255/12; B32B 2307/7265; B32B 2317/12

(57) ABSTRACT

A recyclable corrugated board can include a first outer layer, a second outer layer, and a non-wicking medium attached to and disposed between the first outer layer and the second outer layer. The non-wicking medium is not impregnated and is not coated. The non-wicking medium can be corrugated paper, for example.

### CROSS-REFERENCE TO RELATED APPLICATION

This application claims the benefit of U.S. Provisional Patent Application No. 63/209,213 filed Jun. 10, 2021. The disclosure of which is incorporated herein by reference in its entirety.

### FIELD

This disclosure relates to corrugated board.

### BACKGROUND

Certain corrugated board is made water resistant with a wax coating. The wax coating renders the corrugated board not recyclable.

Such conventional methods and systems have generally been considered satisfactory for their intended purpose. However, there is still a need in the art for improved corrugated board. The present disclosure provides a solution for this need.

### SUMMARY

A recyclable corrugated board can include a first outer layer, a second outer layer, and a non-wicking medium attached to and disposed between the first outer layer and the second outer layer. The non-wicking medium is not impregnated and is not coated. The non-wicking medium can be corrugated paper, for example.

In certain embodiments, the non-wicking medium is non-wicking such that a 24-hour edgewick-test wick distance from an edge is less than about 6 mm. In certain embodiments, the non-wicking medium has a basis weight of about 18 to about 45 pounds per thousand square feet.

The first outer layer and the second outer layer can be attached to the non-wicking medium at one or more peaks of the non-wicking medium using a water resistant adhesive. The first outer layer and second outer layer can be paper liner.

In certain embodiments, the first outer layer and the second outer layer can be non-wicking. The first outer layer and the second outer layer can each include a low Cobb value coating on an outer surface thereof that does not prevent the board from being recyclable.

The low 30-minute exposure time Cobb value coating can have a Cobb value of less than about 85 grams per square meter. The low Cobb value coating can be or include waterproof starch, for example.

In accordance with at least one aspect of this disclosure, a recyclable package can include any suitable embodiment of a recyclable corrugated board as disclosed herein, e.g., as described above. The package can be formed or configured to be used as any suitable packaging.

In accordance with at least one aspect of this disclosure, a method can include attaching a first outer layer to a corrugated non-wicking medium on a first side of the non-wicking medium using a water resistant adhesive, and attaching a second outer layer to the corrugated non-wicking medium on the second side of the non-wicking medium using a water resistant adhesive to form a water resistant corrugated board without using wax. The method can include coating the first outer layer and the second outer layer with a low Cobb coating.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic cross-sectional view of an embodiment of a recyclable corrugated board in accordance with this disclosure;

FIG. 2 is a perspective view of an embodiment of an edgewicking experiment in accordance with this disclosure;

FIG. 3 shows the results of the edgewicking experiment of FIG. 2 of different sample types and different mill locations;

FIGS. 4A, 4B, and 4C are charts showing numerical results from the edgewicking experiments for different sample types and mill locations;

FIG. 5 shows the results of the edgewicking experiment of FIG. 2 of a certain sample type from different mills; and

FIG. 6 is a chart showing numerical results from the edgewicking experiment for the samples and mills of FIG. 5.

### DETAILED DESCRIPTION

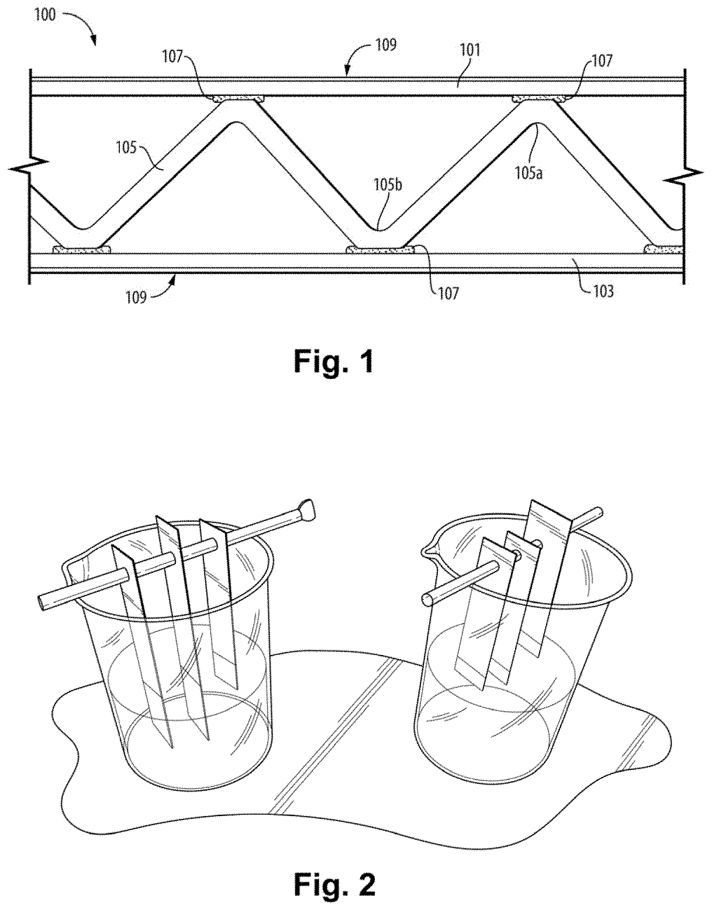

Reference will now be made to the drawings wherein like reference numerals identify similar structural features or aspects of the subject disclosure. For purposes of explanation and illustration, and not limitation, an illustrative view of an embodiment of a corrugated board (e.g., recyclable and water resistant) in accordance with the disclosure is shown in FIG. 1 and is designated generally by reference character 100. Certain embodiments described herein can be used to provide a water resistant/moisture resistant package that can still be recycled (e.g., as wax is not required).

A recyclable corrugated board 100 can include a first outer layer 101, a second outer layer 103, and a non-wicking medium 105 attached to and disposed between the first outer layer 101 and the second outer layer 103. In certain embodiment, the non-wicking medium is not impregnated and is not coated. The non-wicking medium 105 can be corrugated paper, for example. As shown, the non-wicking medium 105 can include a fluted shape, e.g., formed using a fluting machine on liner paper or other suitable medium as appreciated by those having ordinary skill in the art.

In certain embodiments, the first outer layer 101 and the second out layer 103 can be low or non-wicking as well, and/or have a low Cobb value (e.g., 80 or less). In certain embodiments, the layers 101, 103 can be machine finished paper.

In certain embodiments, the non-wicking medium 105 can be non-wicking such that a 24-hour edgewick-test wick distance from an edge is less than about 6 mm. In certain embodiments, the non-wicking medium can be Enduraliner™ sold by WestRock of Roanoke Rapids, N.C. This particular medium displays certain unique non-wicking properties. In certain embodiments, the non-wicking medium 105 of this type can have a basis weight between about 18 to about 45 pounds per thousand square feet, which provide a desired compression characteristics. Any other suitable basis weight for any suitable application is contemplated herein. Any other suitable non-wicking material(s) that is/are recyclable are contemplated for use as the non-wicking medium 105 (e.g., materials displaying non-wicking characteristics as defined in an edgewicking test described below).

The first outer layer 101 and the second outer layer 103 can be attached to the non-wicking medium 105 at one or more peaks 105a, 105b of the non-wicking medium 105 using a water resistant adhesive 107 (e.g., starch based with resin). Any suitable water resistant adhesive is contemplated herein.

The first outer layer 101 and second outer layer 103 can be paper liner, for example. In certain embodiments, the first outer layer 101 and the second outer layer 103 can be non-wicking. For example, the layers 101, 103 can be Enduraliner™ sold by WestRock of Fernandina Beach, Fla. or Enduraliner™ sold by WestRock of Panama City, Fla. The first outer layer 101 and the second outer layer 103 can each include a low Cobb value coating 109 on an outer surface thereof that does not prevent the board 100 from being recyclable (e.g., a non-wax coating).

In certain embodiments, without a coating on the outer layers 101, 103, the Cobb value of the outer layers 101, 103 can be about 85 grams per square meter or less. With a low Cobb value coating 109, the Cobb value can be less about 60 grams per square meter, for example (e.g., about 0 to about 30 grams per square meter, e.g., about 15, 20, 25, etc.). The low Cobb value coating 109 can be recyclable. In certain embodiments, the first and second outer layers can be non-wicking low Cobb layers. Cobb value can be determined using the known TAPPI 30-minute Cobb test.

In accordance with at least one aspect of this disclosure, a recyclable package (e.g., a cold storage shipping container) can include any suitable embodiment of a recyclable corrugated board as disclosed herein, e.g., board 100 as described above. The package can be formed or configured to be used as any suitable packaging.

In accordance with at least one aspect of this disclosure, a method can include attaching a first outer layer 101 to a corrugated non-wicking medium 105 on a first side of the non-wicking medium 105 using a water resistant adhesive 107 (e.g., starch). The method can also include attaching a second outer layer 103 to the corrugated non-wicking medium 105 on the second side of the non-wicking medium 105 using a water resistant adhesive 109 to form a water resistant corrugated board (e.g., board 100) without using wax. The method can include coating the first outer layer 101 and the second outer layer 103 with a low Cobb coating (e.g., waterproof starch) that is recyclable.

Embodiments can replace wax impregnated corrugate with a recyclable alternative that is still waterproof or water/moisture resistant (e.g., for cold storage applications). Currently, waterproof paper corrugate packaging has wax on it, but this is not recyclable. Embodiments can include liners on the outside that are coated with a non-wax material, e.g., starch.

Embodiments include a low wicking medium for the corrugate layer. Even if a raw board edge is exposed to water/moisture where there is no waterproof coating, such materials will prevent wicking of the fluid. This is an advantage not currently present in wax coated boards. Certain recyclable materials, e.g., as disclosed above, have a low wicking phenomenon (e.g., containerboard from Westrock of Roanoke Rapids).

Certain factors/components that may affect wicking performance include, for example, fiber type (e.g., Virgin pine, Virgin hardwood, and recycled fibers for improved non-wicking) recycled fiber type (OCC, DLK, newsprint, mixed paper), recycled content level, fiber refining level, fiber length, % fines, % ash content, Kappa # or lignin content, sizing chemistry and dosage level, Alkenyl Succinic Anhydride (ASA), Alum, Alkenyl ketene dimers (AKD), rosin sizing, wet end pH level, wet press load(s), porosity and porous fiber structure and uniformity, and/or single vs multi-ply paper structure.

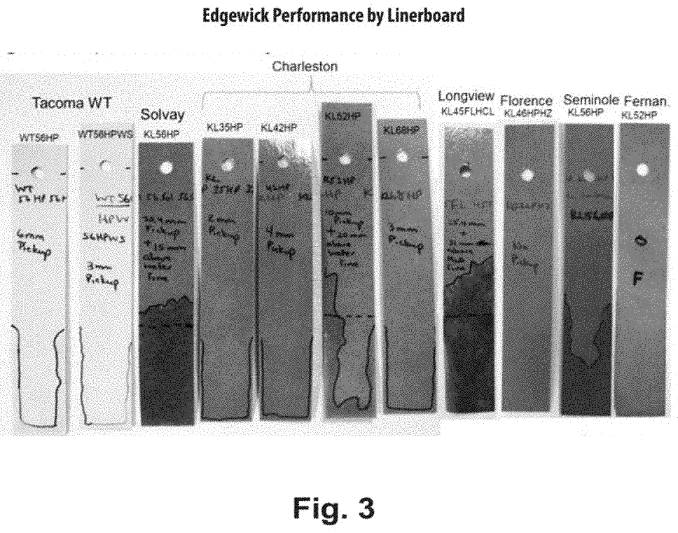

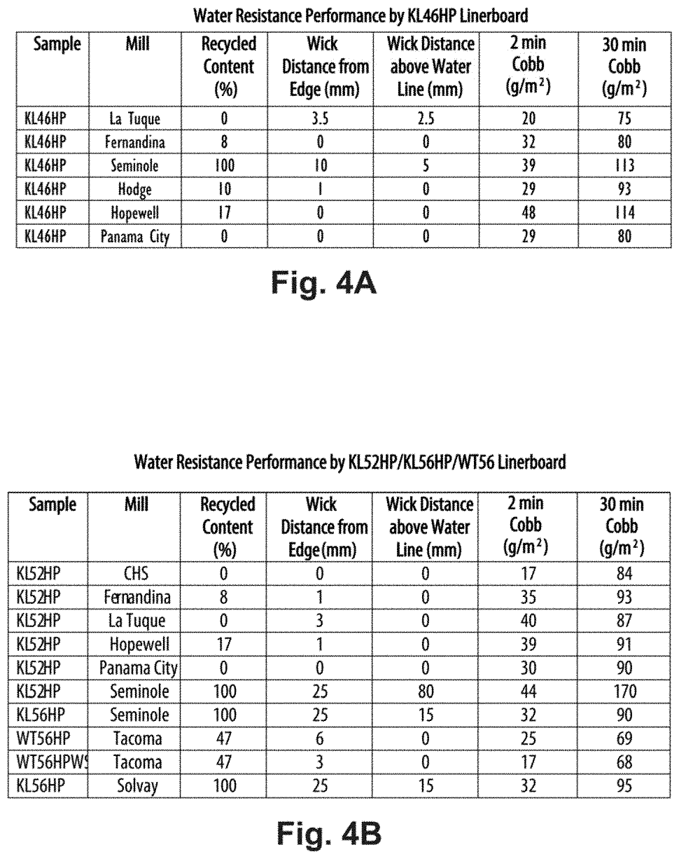

Referring to FIGS. 2 and 3, a test for edgewicking (wicking only from the edge of the material) can include laminating a sample on both sides with a waterproof medium (e.g., mylar film laminated at about 340 degrees F.). The sample can be cut to about 1 inch by about 6 inches, or any other suitable dimensions) to form a rectangle with exposed (uncoated) edges. The sample can then be placed partially submerged in a container with water (e.g., 600 ml of water at room temperature in a 1000 ml beaker). The sample can be submerged about 2 inches below the water line for about 24 hours. After the 24 hours, the samples can be removed and measured. The test can include measuring the distance from the edge that the wicking line is shown, and/or measuring distance above the 2 inch mark if applicable.

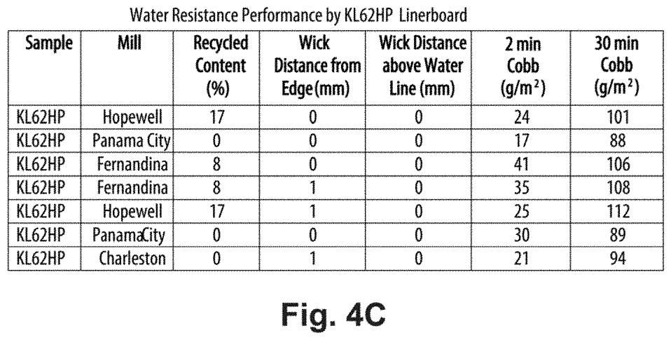

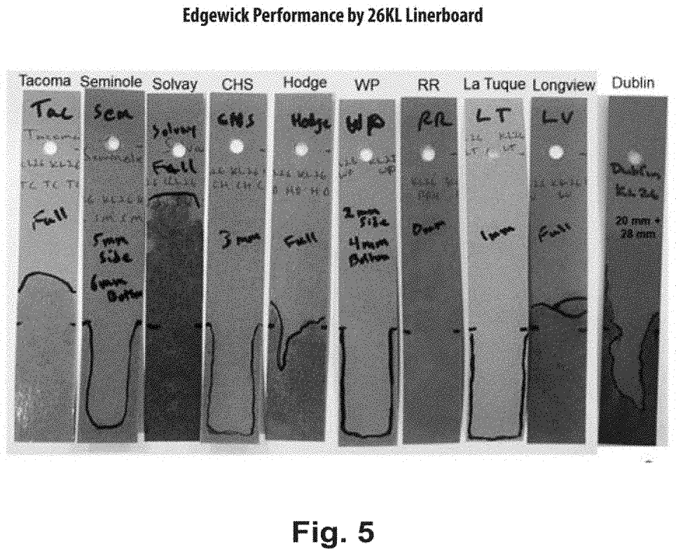

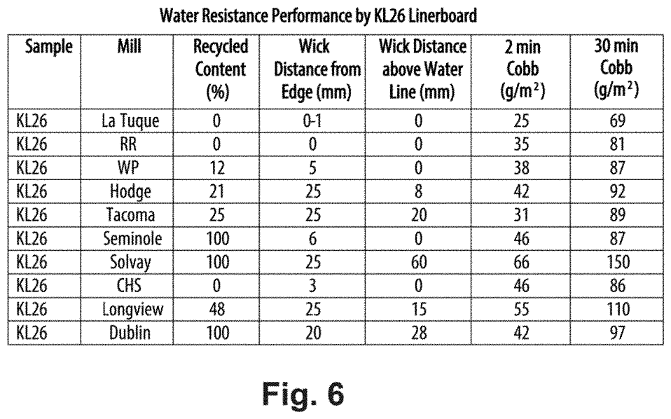

Using such a test, results were obtained for various samples of various compositions from various mills. The results are shown in FIGS. 3, 4A, 4B, 4C, 5, and 5. FIG. 3 shows the results of the edgewicking experiment of different sample types and different mill locations. FIGS. 4A, 4B, and 4C are charts showing numerical results from the edgewicking experiments for different sample types and mill locations. FIG. 5 shows the results of the edgewicking experiment of a certain sample type from different mills. FIG. 6 is a chart showing numerical results from the edgewicking experiment for the certain sample type from different mills.

As shown, certain linerboards displayed absolutely no wicking at all. As used herein, the term “non-wicking” can be meant to include materials that are either non-wicking completely (e.g., 0 mm wicking from edge) or substantially non-wicking. For example, the term “non-wicking” can include shown samples that displayed less than about 6 mm of wicking from the edge.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A recyclable corrugated board, comprising:
a first outer layer;
a second outer layer; and
a non-wicking medium attached to and disposed between the first outer layer and the second outer layer, wherein the non-wicking medium is not impregnated and is not coated.

2. The corrugated board of claim 1, wherein the non-wicking medium is corrugated paper.

3. The corrugated board of claim 2, wherein the non-wicking medium is non-wicking such that a 24-hour edgewick-test wick distance from an edge is less than about 6 mm.

4. The corrugated board of claim 3, wherein the non-wicking medium has a basis weight of about 18 to about 45 pounds per thousand square feet.

5. The corrugated board of claim 4, wherein the first outer layer and the second outer layer are attached to the non-wicking medium at one or more peaks of the non-wicking medium using a water resistant adhesive.

6. The corrugated board of claim 5, wherein the first outer layer and second outer layer are machine finished paper.

7. The corrugated board of claim 6, wherein the first outer layer and the second outer layer are non-wicking such that a 24-hour edgewick-test wick distance from an edge is less than about 6 mm.

8. The corrugated board of claim 6, wherein the first outer layer and the second outer layer each include a low Cobb value coating on an outer surface thereof that does not prevent the board from being recyclable.

9. The corrugated board of claim 8, wherein the low Cobb value coating has a Cobb value of less than about 85 grams per square meter.

10. The corrugated board of claim 9, wherein the first and second outer layers are non-wicking and low Cobb layers.

11. A recyclable package, comprising:
a recyclable corrugated board, comprising:
a first outer layer;
a second outer layer; and
a non-wicking medium attached to and disposed between the first outer layer and the second outer layer, wherein the non-wicking medium is not impregnated and is not coated.

12. The package of claim 11, wherein the non-wicking medium is corrugated paper.

13. The package of claim 12, wherein the non-wicking medium is non-wicking such that a 24-hour edgewick-test wick distance from an edge is less then about 6 mm.

14. The package of claim 13, wherein the non-wicking medium has a basis weight of about 18 to about 45 pounds per thousand square feet.

15. The package of claim 14, wherein the first outer layer and the second outer layer are attached to the non-wicking medium at one or more peaks of the non-wicking medium using a water resistant adhesive.

16. The package of claim 15, wherein the first outer layer and second outer layer are paper liner.

17. The package of claim 16, wherein the first outer layer and the second outer layer are non-wicking.

18. The package of claim 16, wherein the first outer layer and the second outer layer each include a low Cobb value coating on an outer surface thereof that does not prevent the board from being recyclable.

19. A method, comprising:
attaching a first outer layer to a corrugated non-wicking medium on a first side of the non-wicking medium using a water resistant adhesive; and
attaching a second outer layer to the corrugated non-wicking medium on the second side of the non-wicking medium using a water resistant adhesive to form a water resistant corrugated board without using wax.

20. The method of claim 19, further comprising:
coating the first outer layer and the second outer layer with a low Cobb coating.
